(19) United States
(12) Patent Application Publication
(10) Pub. No.: US 2013/0184891 A1
(43) Pub. Date: Jul. 18, 2013

(54) UNINTERRUPTIBLE POWER SUPPLY CONTROL

(71) Applicant: Sahba Etaati, Redwood City, CA (US)

(72) Inventor: Sahba Etaati, Redwood City, CA (US)

(21) Appl. No.: 13/351,331

(22) Filed: Jan. 17, 2012

(51) Int. Cl. G06F 1/26

(52) U.S. Cl. 700/295

(57) ABSTRACT

An example system includes a load, one or more power supplies to provide power to the load, an uninterruptible power supply (UPS) to provide power to the load, a logic device communicatively coupled to the one or more power supplies and the UPS, and a computing device communicatively coupled to the one or more power supplies and the UPS. The logic device is to receive an alternating current (AC) input failure signal and a direct current (DC) output failure signal from each of the one or more power supplies. The logic device is further to enable the UPS which was previously in standby or OFF mode in response to receiving at least one of the AC input failure signal and the DC output failure signal. The computing device is to monitor the one or more power supplies and disable the UPS.

### BACKGROUND

An uninterruptible power supply (UPS) is generally a device that provides finite power to a load in response to a primary power source failure or disruption. This power ensures that the load and related systems continue operating notwithstanding the power source failure or disruption. For instance, an UPS may be used to replace or supplement a primary power source in the event of a blackout or brownout. This functionality may prevent data loss and downtime in business environments were reliability is critical (e.g., data centers, stock exchanges, etc.), and may safeguard the general public in environments were momentary downtime may result in injury or even loss of life (e.g., emergency call centers, military installations, etc.). Furthermore, this UPS functionality may keep power flowing to devices long enough for all pending data to be saved and for the devices to be shut down properly. UPS technology, consequently, while often overlooked and in the background, plays a key role in reliably delivering services in almost every technology space.

### BRIEF DESCRIPTION OF THE DRAWINGS

Example embodiments are described in the following detailed description and in reference to the drawings, in which:

FIG. 1 depicts a system in accordance with an embodiment;

FIG. 2 depicts a system in accordance with another embodiment;

FIG. 3 depicts a process flow diagram of a method in accordance an embodiment; and

FIG. 4 depicts a process flow diagram of a method in accordance another embodiment.

### DETAILED DESCRIPTION

Various embodiments described herein provide a novel and previously unforeseen approach to controlling an UPS. In particular, various embodiments utilize a logic device to immediately turn ON an UPS that was previously in standby or OFF mode in response to receiving a failure signal directly from a power supply, and further utilizes a computing device to monitor the system and override the instruction from the logic device in response to a determination that the power supply is functioning properly or can support the load without power from the UPS. As described in greater detail below, this approach mitigates latencies, expenses, and/or inefficiencies associated with conventional approaches.

Conventionally, in a system utilizing an “off-the-shelf” power supply to support a load, the corresponding UPS control circuitry follows one of the following approaches. One approach is to continuously keep the UPS in an ON or enabled state, and to have an UPS set point or trigger point below the regulation voltage level on the power bus. For example, in a 12V system with +/−5% regulation, the normal operating range is 11.4V-12.6V, and therefore the UPS set point may be 10.8V to ensure that the UPS is not unnecessarily current sharing with the primary power supply. That is, when the voltage level on the power bus drops to 10.8V, the UPS begins outputting 10.8V power to the load. As a result, the 12V load must be able to utilize the 10.8V input from the UPS. This generally requires the load to have a charge pump to create a higher voltage from the 10.8V UPS input, or requires the load to tolerate wide input voltages, either of which is often undesirable and/or not feasible. Furthermore, this approach generally requires the load to tolerate noise transients because there is a tendency to set UPS set point close to the normal operating range minimum value.

An alternative approach is to keep the UPS in OFF or standby mode and to enable the UPS when the voltage level on the power bus drops below a threshold level. For example, in a 12V system with +/−5% regulation and a normal operating range of 11.4V-12.6V, the system may detect when the voltage level on the power bus drops below, e.g., 11.2V, and enable the UPS in response to this event. The drawback of this approach is that the voltage may be in a sharp decline when the 11.2V threshold on the power bus is breached, and the UPS may not have enough time to become fully operational before the load loses its operating power from the power supply. Moreover, the load may have to tolerate wide input ranges and noise transients, as discussed above.

Various embodiments described herein address at least the above-mentioned drawbacks associated with conventional UPS approaches as well as provide additional enhancements to UPS control. In particular, various embodiments enable the UPS to be switched from standby/OFF mode without requiring the load to tolerate wide input ranges, cope with noise transients, and/or include additional costly components such as charge pumps. Moreover, various embodiments enable the UPS to initialize in a rapid manner based on signaling received directly from the power supply (as opposed to monitoring the power bus), and therefore does not risk loss of operating power to the load. Additionally, various embodiments enable the UPS to be turned OFF based on a determination that UPS power is not required, and enable components to be controlled and power fail procedures to be implemented in an efficient manner. Still further, various embodiments utilize predominantly hardware (e.g., a logic device) to immediately enable an UPS in standby or OFF mode in response to receiving an alternating current (AC) and/or direct current (DC) fail signal directly from a power supply, and utilize software (e.g., running on a microcontroller) to monitor the situation after the UPS is enabled and override the enable command if necessary. This approach reduces latency associated with conventional systems that must interrupt software before issuing an UPS enable command, and therefore provides significant advantages in, e.g., 12V environments where regulation margins are tight and UPS initiation timing is critical.

In one example embodiment, a system is provided. The system comprises a load, one or more power supplies configured to provide power to the load, an UPS configured to provide power to the load, a logic device communicatively coupled to the one or more power supplies and the UPS, and a computing device communicatively coupled to the one or more power supplies and the UPS. The logic device is configured to receive an AC input failure signal and a DC output failure signal from each of the one or more power supplies, and further configured to enable the UPS, which was previously in standby or OFF mode, in response to receiving at least one of the AC input failure signal and the DC output failure signal. The computing device is configured to monitor the one or more power supplies and disable the UPS.

In another example embodiment, a method is provided. The method comprises monitoring, by one or more power supplies, an AC input level and a DC output level, and sending at least one of an AC input failure signal and a DC output failure signal to a logic device in response to a determination that the AC input level or DC output level has dropped below a predetermined value. The logic device receives at least one of the AC input failure signal and the DC output failure signal and transmits an UPS enable signal to enable an UPS that was previously in standby or OFF mode. A computing device then monitors the one or more power supplies and transmits a disable signal to the UPS that causes the UPS to transition to standby mode or OFF mode.

In still another example embodiment, a system is provided. The system comprises a load; one or more power supplies; an UPS; a power bus coupled to the load, the one or more power supplies, and the UPS; a programmable logic device (PLD) communicatively coupled to the one or more power supplies and the UPS; a computing device communicatively coupled to the one or more power supplies and the UPS; and a cooling mechanism. The PLD is configured to enable the UPS which was previously in standby or OFF mode, and the computing device is configured to monitor the one or more power supplies and place the UPS in standby or OFF mode or enable the cooling mechanism based at least in part on the monitoring.

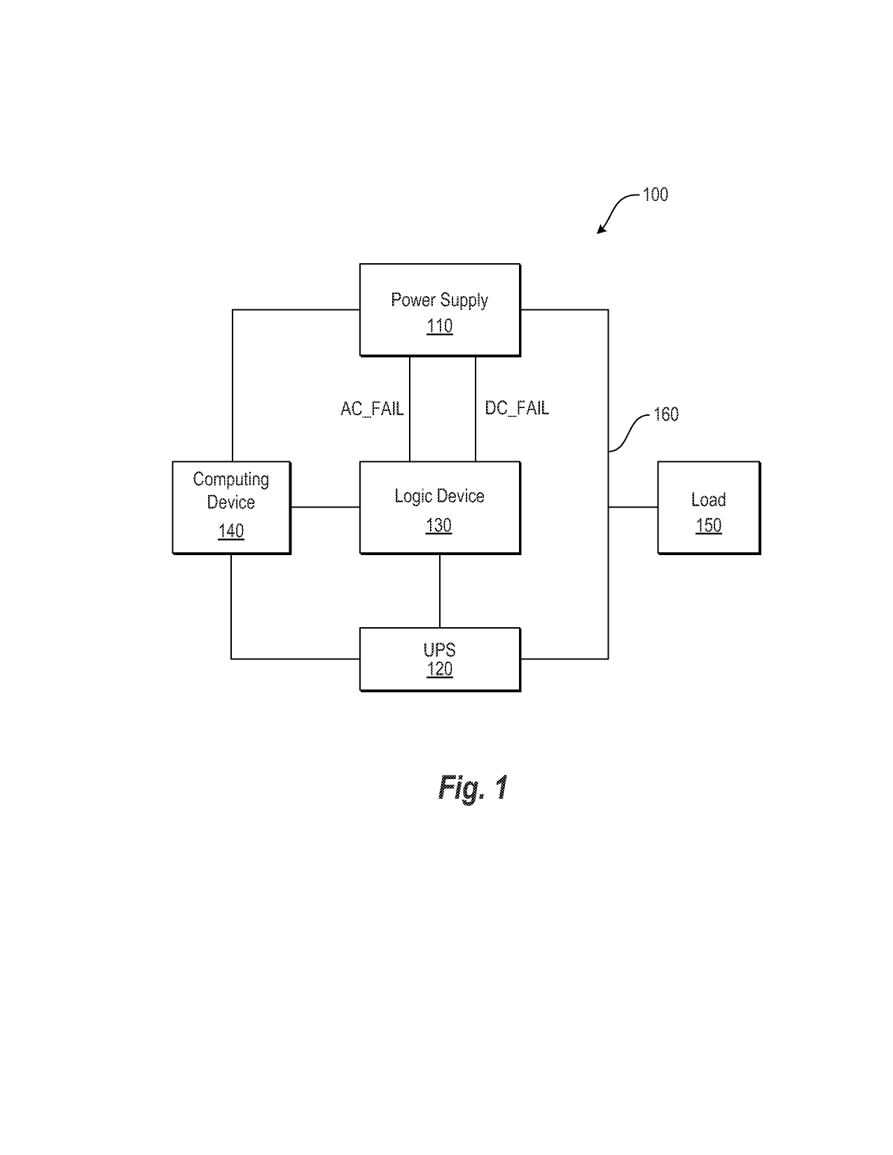

FIG. 1 depicts a system 100 in accordance with one embodiment. The system 100 may form at least part of one or more devices that benefit from and/or provide uninterrupted power. For example, the system 100 may form at least part of a storage device, a server, a switch, a router, a power supply, and/or a client device. It should be readily apparent that the system depicted in FIG. 1 represents a generalized illustration and that other components may be added or existing components may be removed, modified, or rearranged without departing from a scope of the present disclosure. For example, while one power supply is depicted in FIG. 1, the system 100 may comprise more than one power supply in accordance with various embodiments of the present disclosure.

As shown, the system 100 comprises a power supply 110, an UPS 120, a logic device 130, a computing device 140, a load 150, and a power bus 160, each of which are described in greater detail below.

The power supply 110 is generally a device configured to provide power to the load 150. The power supply 110 may be, e.g., an AC/DC power supply or a DC/DC power supply. In the case of AC/DC, the power supply 110 may comprise an AC/DC converter to convert, e.g., 100-240V AC to 12V DC. This may be accomplished via rectification, filtration, regulation, and/or isolation, and utilize one or more converters, transformers, rectifiers, capacitors, resistors, inductors, diodes, and/or regulators.

The UPS 120 is generally a device configured to provide short-term power via internal cells in response to a failure and/or disruption of the power supply 110. For example, the UPS 120 may be configured to replace or supplement power to the load 150 in the event of a power failure (e.g., a blackout) and/or power sag (e.g., a brownout) via its internal cells. Such internal cells may comprise, for example, one or more flow batteries, lead-acid batteries, lithium air batteries, lithium-ion batteries, lithium iron phosphate batteries, lithium-sulfur batteries, lithium-titanate batteries, molten salt batteries, nickel-cadium batteries, nickel hydrogen batteries, nickel-iron batteries, nickel metal hydride batteries, nickel-zinc batteries, organic radical batteries, polymer-based batteries, polysulfide bromide batteries, potassium-ion batteries, alkaline batteries, silicon air batteries, sodium-ion batteries, super iron batteries, zinc-bromine flow batteries, and zinc matrix batteries. The UPS 120 may charge these internal cells via electrical energy provided via AC input or via DC power received from the power supply 110. The UPS 120 may utilize a charge circuit to maximize the lifetime of the internal cells. This charge circuit may perform, e.g., a two-step constant current/constant voltage charge.

In some embodiments, the power supply 110 and the UPS 120 may be arranged in a parallel configuration (as opposed to a series configuration), where the output of the power supply 110 and the UPS 120 are tied together and provide power along the power bus 160 to the load 150. In addition, the UPS 120 may provide an output voltage consistent with the output voltage provided by the power supply 110. For example, if the power supply 110 provides 12V DC output, the UPS 120 may similarly provide 12V DC output when enabled. Moreover, the UPS 120 may be capable of providing full power to the load 150 if necessary. For example, if the power supply 110 provides 500 W to the load 150, the UPS 130 may similarly provide 500 W to the load 150 for a finite time period.

In further embodiments, the power supply 110 and the UPS 120 may be arranged to actively or passively current share (e.g., in the case of a power sag). Active current sharing may be implemented with circuitry to actively measure, e.g., phase currents, and actively adapt drive signals such that current share imbalances between the power supply 110 and UPS 120 are minimized. For example, the current imbalances may be +/−10% or less when active current sharing is utilized. Passive current sharing, by contrast, may be implemented with internal and/or external resistances to distribute current relatively evenly and may involve matching drive signals and power handling components. Imbalances for passive current sharing may be, for example, +/−30% or less when passive current sharing is utilized.

The logic device 130 is generally a fixed or programmable logic device that performs functions in response to an input. For example, the logic device 130 may be a programmable logic device (PLD) such as a complex programmable logic device (CPLD), field programmable logic device (FPGA), programmable logic array (PLA), programmable array logic (PAL), or generic array logic (GAL). The logic device 130 may be configured to receive at least two signals from the power supply 110. The first signal may indicate the status of the AC input (e.g., AC_FAIL), and the second signal is a signal may indicate the status of the DC output (e.g., DC_FAIL). In addition or alternatively, the logic device 130 may receive a signal such as PS_OK that combines AC input and DC output status and indicates in a single signal the status of the power supply 110. Hence, the power supply 110 is generally configured to output signals indicating whether the AC input and/or DC output is at an expected level based on internal measurements. In response to receiving an indication that either the AC input or DC output of the power supply 110 is not at its expected level, the logic device 130 is configured to immediately enable the UPS 120 from standby or OFF mode. For example, in response to a blackout or brownout condition, the power supply 110 may output an AC_FAIL signal or the like because the AC input level has dropped, and also output a DC_FAIL signal or the like because the DC output level has dropped as a result of the drop in AC input. In response to receiving one or both of these signals, the logic device 130 may immediately send a signal to the UPS 120 that causes the UPS 120 to transition from standby/OFF mode to enabled/active/ON mode. Thus, the UPS 120 may initialize and begin providing the power to the load 150 necessary to supplement or replace the power provided by the power supply 110. In another example, the logic device 130 may only receive a DC_FAIL signal or the like from the power supply 110 (i.e., not receive an AC_FAIL signal or the like from the power supply 110). This may occur when the AC input is proper, but the DC output is improper because, e.g., an internal component such as an AC/DC converter is not functioning as expected. The logic device 130, upon receiving the DC_FAIL signal, may immediately send a signal to the UPS 120 which causes the UPS to transition from standby/OFF mode to enabled/active/ON mode.

The computing device 140 is generally a device configured to carry out operations by executing instructions stored on an internal or external non-transitory computer-readable medium. For example, the computing device 140 may be a microprocessor, a central processing unit (CPU), a processor, a microcontroller, or an application-specific integrated circuit (ASIC). The non-transitory computer-readable medium may be, for example, a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. The computing device 140 may reside on a printed circuit board (PCB) and be electronically coupled to the power supply 110, UPS 120, and/or logic device 130.

The computing device 140 may be configured to override the logic device 130 and turn OFF or place the UPS 120 in standby mode if the computing device 140 determines that it is not necessary for the UPS 120 to be enabled. More particularly, the computing device 140 may be interrupted when the logic device 130 enables the UPS 120. The computing device may then proceed to monitor and evaluate the state of the power supply 110. This may include the computing device 140 receiving AC input measurements (current and/or voltage), DC output measurements (current and/or voltage), and/or other signals/measurements that help the computing device 140 assess the status of the power supply 110. The computing device 140 may then determine, based on these measurements, if it is or was necessary to enable the UPS 120. If the computing device 140 determines that it is or was not necessary to enable the UPS 120, the computing device 120 may override the signaling from the logic device 130 and turn OFF or place the UPS 120 in standby mode by transmitting a disable, OFF, standby, or the like message to the UPS 120. This may occur, for example, if the computing device 140 determines that the power supply input and output levels are proper, and the AC_FAIL signal and/or DC_FAIL signal from the power supply 110 was triggered by a momentary or transitory power fluctuation. Further, this may occur, for example, in response to a determination that, while one power supply 110 may not be operating as expected, one or more other power supplies 110 are capable of delivering the power required by the load without assistance from the UPS 120.

If, on the other hand, the computing device 140 determines that it is or was necessary for the UPS 120 to be enabled, the computing device may proceed to initiate one or more power fail procedures. Such power fail procedures may include alerting other components of the situation and causing these devices to begin storing information and preparing for a potential shutdown when the UPS 120 power depletes. Additionally, such power fail procedures may include placing various components in a low power state so as to conserve as much power as possible while on UPS 120 power. Still further, the power fail procedures may include logging the power fail event and/or causing an alert to be transmitted to inform, e.g., an administrator that the system is temporarily running on UPS 120 power.

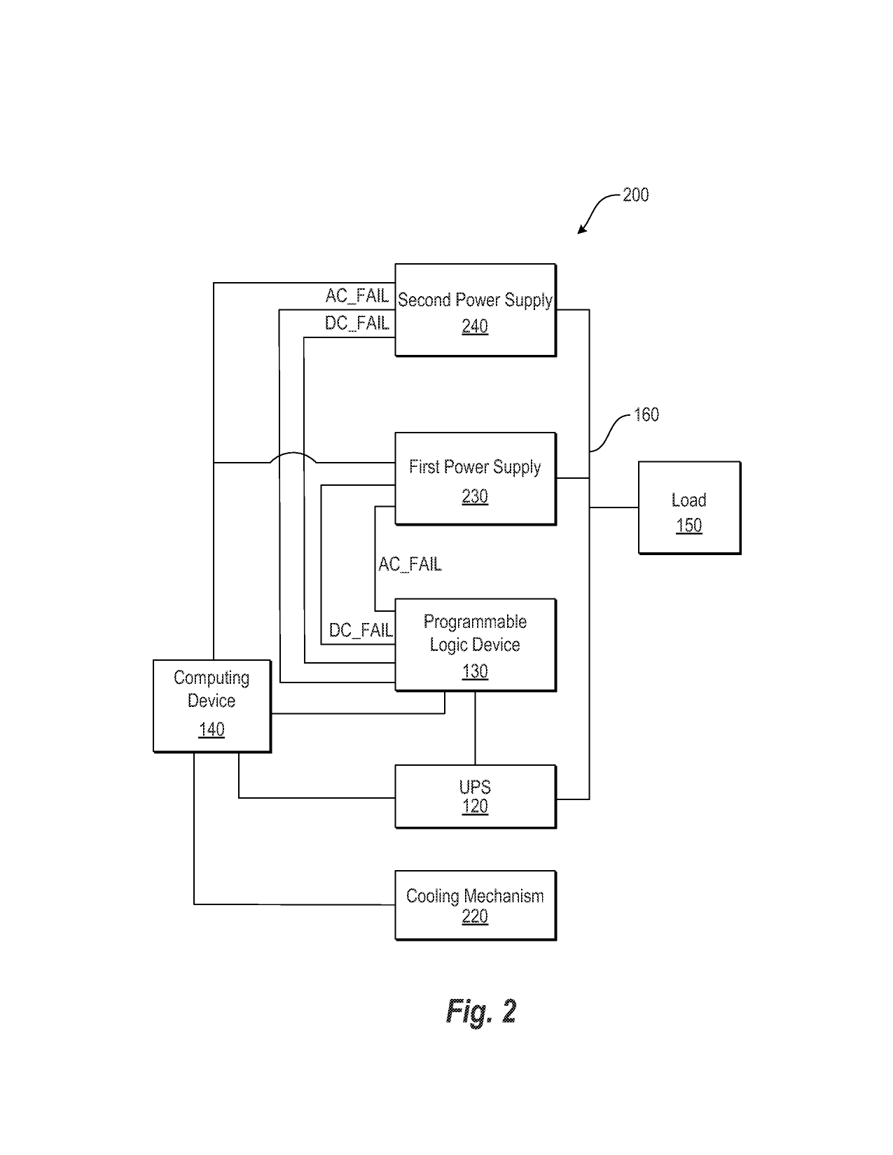

FIG. 2 depicts another system 200 in accordance with one embodiment. The system 200 is similar to the system 100 depicted in FIG. 1; however, the logic device 130 is replaced with a programmable logic device 210 and the power supply 110 is replaced by a first power supply 230 and a second power supply 240. In addition, a cooling mechanism 220 is electronically coupled to the computing device 140. Depending on implementation, the cooling mechanism 200 may be internal or external to the UPS 120. It should be readily apparent that the system depicted in FIG. 2 represents a generalized illustration and that other components may be added or existing components may be removed, modified, or rearranged without departing from a scope of the present disclosure.

Similar to system 100, the programmable logic device 210 is configured to receive AC input failure and/or DC output failure signals from each of the first power supply 230 and second power supply 240. In response to receiving either of these signals, the programmable logic device 210 is configured to immediately transmit a signal to enable the UPS 120. Thereafter, the computing device 140 monitors and evaluates the first power supply 230 and the second power supply 240 to determine if it is necessary for the UPS 120 to be active. If the computing device 140 determines that, for example, the first power supply 230 is malfunctioning but he second power supply 240 can adequately compensate and supply power to the load 150, the computing device 140 may transmit a disable signal or the like to the UPS 120 to place the UPS 120 back in standby or OFF mode. Conversely, if the computing device 140 determines that it is necessary for the UPS to be active, the computing device 140 may proceed to initiate power fail procedures. In addition to the above-mentioned power fail procedures, the computing device may proceed to activate the cooling mechanism 220 (e.g., a cooling fan) after a predetermined period (e.g., 15 seconds after the UPS was enabled) to dissipate heat generated by the UPS 120. By waiting this predetermined time period, resources are not used to power the cooling mechanism 220 until the UPS 120 actually begins producing heat that needs to be dissipated. Also, this predetermined time period allows the computing device 140 to evaluate the status of the first power supply 230 and/or second power supply 240 and determine if the UPS 120 and associated cooling mechanism 220 need to be enabled.

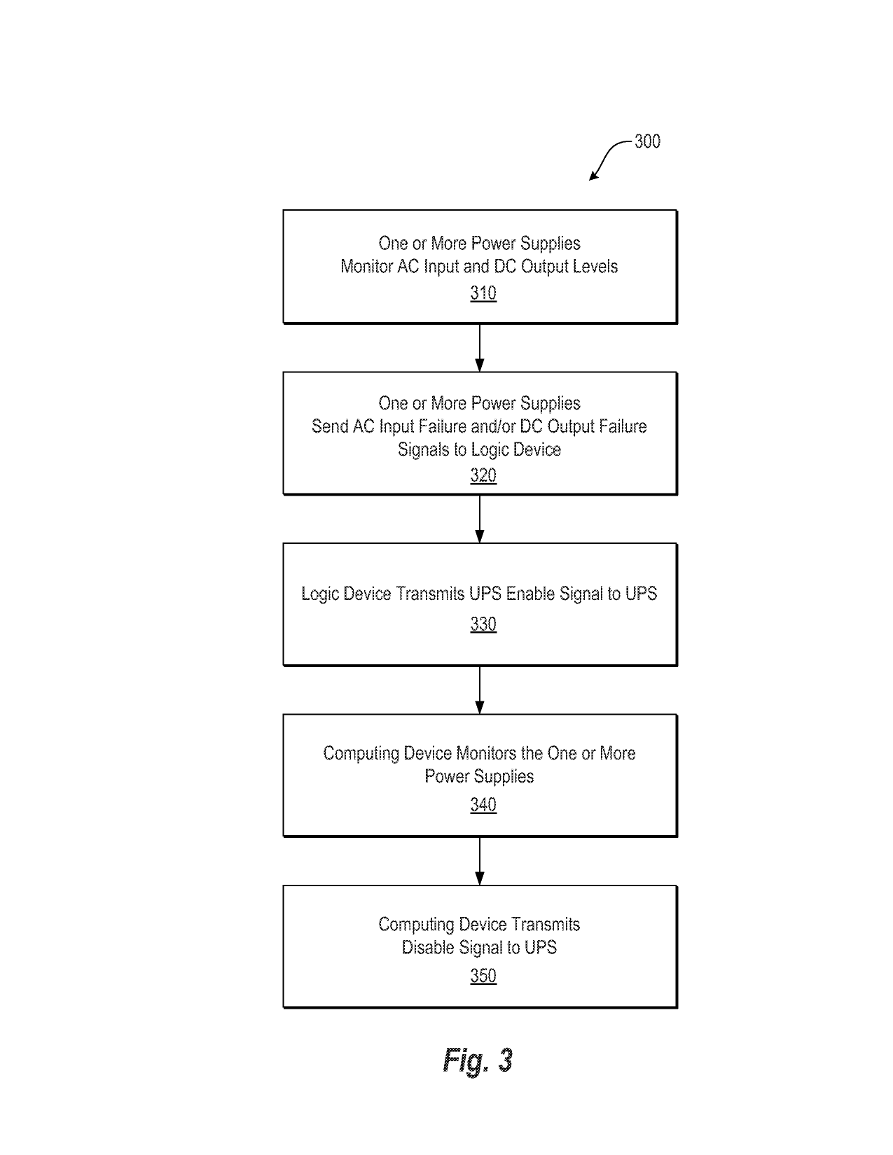

FIG. 3 depicts a process flow diagram of a method 300 in accordance with one embodiment. The depicted process may be conducted by one or more power supplies, a logic device, and/or a computing device. It should be readily apparent that the processes depicted in FIG. 3 represents a generalized processes and that other processes may be added or existing processes may be removed, modified, or rearranged without departing from a scope of the present disclosure.

The method 300 may begin at block 310, wherein one or more power supplies monitor AC input levels and DC output levels at each respective power supply. In response to a determination that the AC input level or DC output level has dropped below a predetermined value, at block 320, a power supply sends at least one of an AC input failure signal and a DC output failure signal to a logic device. At block 330, the logic device receives at least one of the AC input failure signal and the DC output failure signal and transmits an UPS enable signal that enables an UPS which was previously in standby or OFF mode. At block 340, the computing device begins monitoring the one or more power supplies. At block 350, the computing device transmits a disable signal to the UPS that causes the UPS to transition to standby or OFF mode.

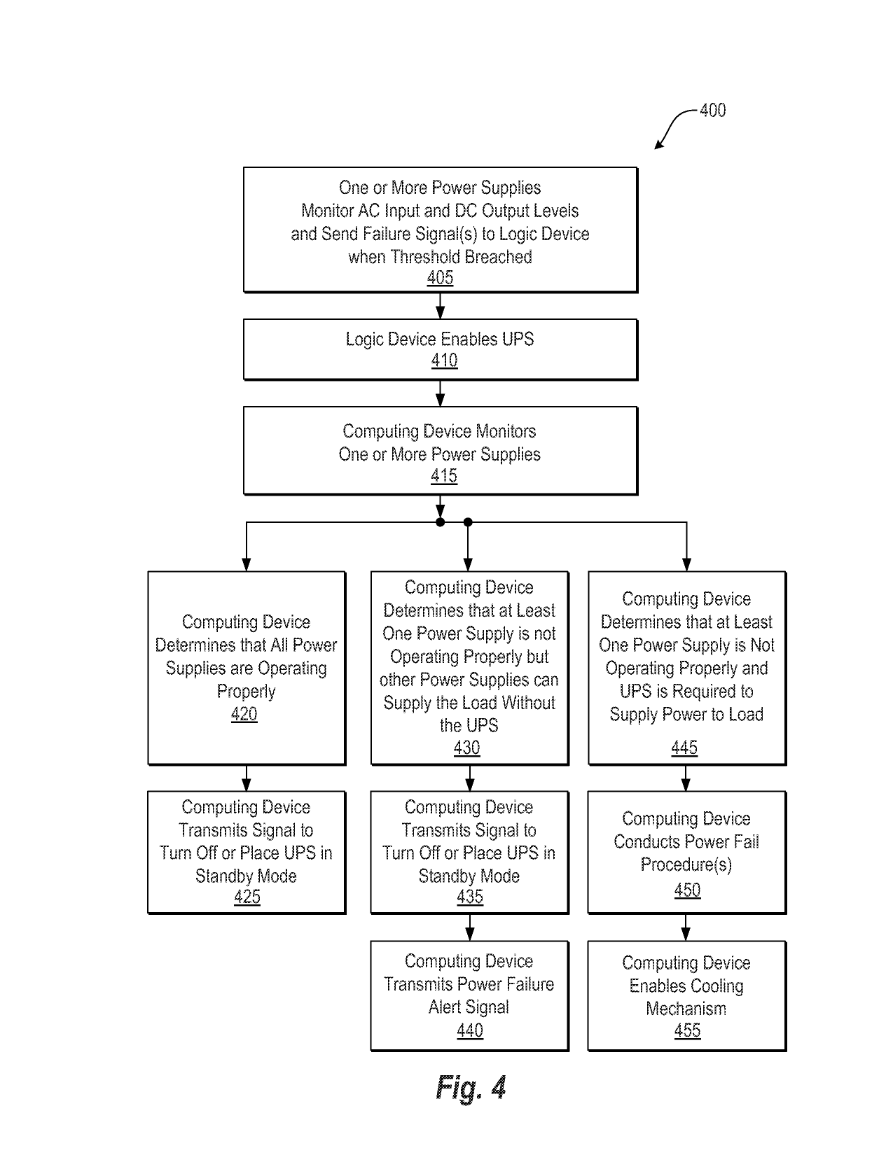

FIG. 4 depicts another process flow diagram of a method 400 in accordance with another embodiment. The depicted process may be conducted by one or more power supplies, a logic device, and/or a computing device. It should be readily apparent that the processes depicted in FIG. 4 represents a generalized processes and that other processes may be added or existing processes may be removed, modified, or rearranged without departing from a scope of the present disclosure.

The method 400 may begin at block 405, wherein the one or more power supplies monitor AC input and DC output levels and determine if a predetermined threshold has been breached. In response to a threshold breach, the one or more power supplies transmit an AC input and/or DC output failure signal to a logic device such as a programmable logic device (PLD). At block 410, in response to receiving the AC input and/or DC output failure signal from the one or more power supplies, the logic device enables the UPS by transmitting an enable signal to the UPS. The UPS, in response to receiving the enable signal, begins transitioning from standby or OFF mode to ON mode. The timing for the above-mentioned processes may be commensurate with the following formula: t_{DETECT+}t_{ASSERT+}t_{ENABLE<}t_{HOLDUP}, where t_{DETECT} is the amount of time for the power supply to detect an AC or DC failure and assert a failure signal; t_{ASSERT} is the amount of time for the logic device to receive and assert the UPS enable signal; t_{ENABLE} is the amount of time for the UPS to power-up to regulation level; and t_{HOLDUP} is the amount of time from the AC or DC failure to the power supply output being out of regulation level. Alternatively, the timing for the above-mentioned processes may be commensurate with the following formula: t_{DETECT+}t_{ASSERT+}t_{ENABLE<}t_{HOLDUP+}t_{MARGIN}, where t_{MARGIN} is the desired margin or buffer time.

At block 415, the computing device begins monitoring the one or more power supplies. This may be caused by the computing device receiving an interrupt signal from the logic device or from another device such as the UPS. The power supply monitoring may include the computing device determining the current, voltage, and/or signal-to-noise level of the AC/DC input/output. The computing device may receive multiple measurements and compare these measurements against expected values for each power supply. The computing device may then, at block 420, determine that all of the power supplies are operating properly. In response to such a determination, at block 425, the computing device transmits a signal to turn OFF the UPS or place the UPS in standby mode.

Alternatively, the computing device, at block 430, may determine that at least one power supply is not operating as expected, but further determine that one or more other power supplies can supply power to the load notwithstanding this power failure. Stated differently, even if one power supply is not functioning properly, the computing device may nonetheless determine that the other power supplies can increase their output to compensate for the loss of one power supply without having to utilize the UPS. Hence, at block 435, the computing device transmits a signal to turn OFF the UPS or place the UPS in standby mode. Furthermore, since there is an issue with at least one power supply, at block 440, the computing device transmits or causes another device to transmit a power failure alert signal. This power failure signal may alert an administrator or another device that a power supply is malfunctioning or not operating as expected so that the condition may be rectified.

Alternatively, the computing device, at block 445, may determine that at least one power supply is not operating properly and power from the UPS is required to satisfy the requirement of the load. In this case, at block 450, the computing device conducts one or more power fail procedures. Such procedures may include alerting other components of the situation and causing these devices to begin storing information and preparing for a potential shutdown when the UPS 120 power depletes, placing various components in a low power state so as to conserve as much power as possible while on UPS 120 power, and/or causing an alert to be transmitted to inform, e.g., an administrator that the system is temporarily running on UPS 120 power. In addition to the above, at block 455, the computing device transmits an enable signal to a cooling mechanism such as a fan associated with the UPS. This enable signal may be transmitted a predetermined time period after the UPS was enabled so as to maximize efficiency by not utilizing the cooling mechanism until there is sufficient heat to dissipate.

In conclusion, various embodiments enable the UPS 120 to remain in standby/OFF mode and be triggered by internal power supply failure detection mechanisms that cause the power supply 110 to output an AC/DC input failure signal and/or a DC output failure signal. These signals are received by a predominantly or completely hardware component, such as logic device, and this hardware component promptly outputs an enable signal which causes the UPS 120 to initiate. At or around the same time, system software running on a computing device 140 is interrupted and the software begins monitoring the status of the power supply for an implementation dependent period of time. Based on this monitoring, the system software may place the UPS 120 back in standby/OFF mode, or let the UPS 120 remain enabled and begin conducting various power fail procedures. Hence, embodiments allow for the UPS 120 to remain in standby/OFF mode and be enabled in a prompt manner by hardware and thereafter controlled by software.

The present disclosure has been shown and described with reference to the foregoing exemplary embodiments. It is to be understood, however, that other forms, details, and embodiments may be made without departing from the spirit and scope of the disclosure that is defined in the following claims.

What is claimed is:

1. A system comprising:
one or more power supplies to provide power to a load;
an uninterruptible power supply (UPS) to provide power to the load;
a logic device communicatively coupled to the one or more power supplies and the UPS; and
a computing device communicatively coupled to the one or more power supplies and the UPS;
wherein the logic device is to receive an alternating current (AC) input failure signal and a direct current (DC) output failure signal from each of the one or more power supplies;
wherein the logic device is further to enable the UPS which was previously in standby or OFF mode in response to receiving at least one of the AC input failure signal and the DC output failure signal; and
wherein the computing device is to monitor the one or more power supplies and disable the UPS.

2. The system of claim 1, wherein the computing device is to disable the UPS in response to a determination that the one or more power supplies are able to provide adequate power to the load without the UPS.

3. The system of claim 1, wherein the computing device is to disable the UPS in response to a determination that all of the one or more power supplies are functioning properly.

4. The system of claim 1, wherein the one or more power supplies and UPS provide 12V output to the load.

5. The system of claim 1, wherein the computing device is further to enable a cooling mechanism a predetermined time period after the logic device enables the UPS.

6. The system of claim 1, wherein the one or more power supplies and the UPS are in a parallel configuration.

7. The system of claim 1, wherein the one or more power supplies and the UPS are arranged to current share.

8. The system of claim 1, wherein the logic device comprises a programmable logic device (PLD).

9. The system of claim 8, wherein the PLD comprises a field-programmable gate array (FPGA) or a complex programmable logic device (CPLD).

10. A method comprising:
monitoring, by one or more power supplies, an alternating current (AC) input level and a direct current (DC) output level;
sending, by the one or more power supplies, at least one of an AC input failure signal and a DC output failure signal to a logic device in response to a determination that the AC input level or DC output level has dropped below a predetermined value;
receiving, by the logic device, at least one of the AC input failure signal and the DC output failure signal and transmitting from the logic device an uninterruptible power supply (UPS) enable signal to enable an UPS that was previously in standby or OFF mode;
monitoring, by a computing device, the one or more power supplies; and
transmitting, by the computing device, a disable signal to the UPS that causes the UPS to transition to standby or OFF mode.

11. The method of claim 10, wherein the computing device transmits the disable signal in response to a determination that all of the one or more power supplies are functioning properly.

12. The method of claim 10, wherein the computing device transmits the disable signal in response to a determination that the one or more power supplies are able to provide adequate power to a load without the UPS.

13. The method of claim 10, wherein the one or more power supplies and UPS provide 12V output to a load.

14. The method of claim 10, further comprising transmitting, by the computing device and to a cooling mechanism, an enable signal that enables the cooling mechanism a predetermined time period after the logic device enables the UPS.

15. The method of claim 10, wherein the logic device comprises a programmable logic device (PLD).

16. A system comprising:
one or more power supplies;
a uninterruptible power supply (UPS);
a power bus to couple to a load, the one or more power supplies, and the UPS;
a programmable logic device (PLD) communicatively coupled to the one or more power supplies and the UPS;
a computing device communicatively coupled to the one or more power supplies and the UPS; and
a cooling mechanism,
wherein the PLD is to enable the UPS which was previously in standby or OFF mode; and
wherein the computing device is to monitor the one or more power supplies and place the UPS in standby or OFF mode or enable the cooling mechanism based at least in part on the monitoring.

17. The system of claim 16, wherein the PLD is to enable the UPS in response to receiving an AC input failure signal or DC output failure signal from any of the one or more power supplies.

18. The system of claim 16, wherein the computing device is to place the UPS in standby or OFF mode in response to determining that the PLD enabled the UPS in response to a temporary power fluctuation.

19. The system of claim 16, wherein the computing device is to place the UPS in standby or OFF mode in response to a determination that the other one or more power supplies are able to provide adequate power to the load without the UPS.

20. The system of claim 16, wherein the computing device is to enable the cooling mechanism a predetermined time period after the PLD enables the UPS.
